(19) United States
(12) Patent Application Publication
(10) Pub. No.: US 2006/0040814 A1
(43) Pub. Date: Feb. 23, 2006

(54) Roller for use with substrates bearing printed ink images and a composition for coating the roller

(76) Inventors: Jiann-Hsing Chen, Fairport, NY (US); Joseph A. Pavlisko, Pittsford, NY (US); Robert A. Lancaster, Hilton, NY (US); Po-Jen Shih, Webster, NY (US)

Correspondence Address: Paul A. Leipold;Patent Legal Staff, Eastman Kodak Company, 343 State Street, Rochester, NY, 14650-2201, US

(21) Appl. No.: 11/053,821

(22) Filed: Feb. 9, 2005

Related U.S. Application Data
(60) Provisional application No. 60/543,071, filed on Feb. 9, 2004.

(51) Int. Cl. B25F 5/02

(52) U.S. Cl. 492/52

(57) ABSTRACT

A roller for use as a fusing roller or a pressure roller or a drying roller in a system for treating printed ink image-bearing substrates and a composition for coating the outside of the roller. The composition is a reaction product of a high molecular weight, reactive cross-linkable poly(dialkylsiloxane), a cross-linked poly(dialkylsiloxane) including a filler and a silane cross-linking agent.

### CROSS-REFERENCE TO RELATED APPLICATION

Reference is made to the co-pending, commonly assigned, U.S. Provisional Patent Application Ser. No. 60/543,071 filed on Feb. 9, 2004, entitled: ROLLER FOR USE WITH SUBSTRATES BEARING PRINTED INK IMAGES AND A COMPOSITION FOR COATING THE ROLLER, the disclosure of which is incorporated herein by reference.

### FIELD OF THE INVENTION

This invention relates to rollers which are coated with a special composition for use in printers that require ink drying, fusing, or both for ink image-bearing substrates to improve various durability and other properties of the ink image-bearing substrates.

### BACKGROUND OF THE INVENTION

Ink jet printing is a non-impact printing method which in response to a digital signal produces drops of ink deposited on a recording element or substrate. Ink jet printing systems are used in a variety of capacities in industrial, home and office environments. The quality of ink jet prints and other ink prints continues to improve, however, the ink jet prints are disadvantaged because they lack durability, often being less stable relative to environmental factors of light, ozone, etc and more sensitive to water and abrasion. Various ways of overcoming these disadvantages have been used. Ink prints have been laminated using a transparent overlay that may be adhered to the ink print. The laminating sheets may be adhered directly to the substrate by heat, pressure or both.

Another alternative is the use of substrates that have a nascent protective layer coated on the substrate. During the ink jet printing process, the inks penetrate the layer and after penetration is complete, the layer is fused using heat or pressure or both to seal and protect the print. The ink jet recording material may include a porous top layer that can be thermally fixed after the image has been printed on the substrate. Various other techniques have been used to more firmly fix the ink jet image onto the substrate. In some instances, inks containing fuseable polymer constituents have been used. These fuseable polymer constituents may be fused to improve the stability of the printed image. Unfortunately, when equipment that is used to fuse toner images produced by electrophotographic copying is used for this application, the release of the ink images from the roller surfaces is not satisfactory.

Further, rollers or the like may be used in attempts to dry ink images to reduce the solvent or moisture content of such images either alone or in conjunction with the fusing operations to produce more durable printed images on a substrate.

Accordingly, a continuing effort have been made toward the development of rollers and other equipment which may be used to treat ink jet or other ink images on a substrate to improve the durability and other properties of the ink images on the substrate.

### SUMMARY OF THE INVENTION

This invention comprises a roller for drying, fusing or both drying and fusing ink images on ink image-bearing substrates to produce ink images that have greater durability and other desired properties wherein the roller comprises a metallic core having an outside and an outer coating comprising a reaction product of a high molecular weight, reactive cross-linkable poly(dialkylsiloxane); a cross-linked poly(dialkylsiloxane) including an oxide filler wherein the cross-linked poly(alkylsiloxane) has a weight average molecular weight before cross-linking from about 5,000 to about 80,000; and one or more silane cross-linking agents.

The invention further comprises a composition comprising a reaction product of a high molecular weight, reactive cross-linkable poly(dialkylsiloxane), a cross-linked poly(dialkylsiloxane) including an oxide filler wherein the cross-linked poly(alkylsiloxane) has a weight average molecular weight before cross-linking from about 5,000 to about 80,000, and one or more silane cross-linking agents.

### BRIEF DESCRIPTION OF THE DRAWINGS

FIG. 1 is a schematic diagram of an embodiment of the present invention in combination with other elements of an ink image drying system and an ink image fusing system;

FIG. 2 is a cross-sectional view of an embodiment of a roller according to the present invention for treating a recording element bearing an ink image; and,

FIG. 3 is a cross-sectional view of an alternate embodiment of a roller for use in treating a recording element bearing an ink image;

### DETAILED DESCRIPTION OF THE INVENTION

In the description of the Figures, the same numbers will be used throughout to refer to the same or similar components. Particularly with respect to FIG. 1, only those elements required to describe the present invention will be discussed.

According to the present invention, a roller for use in treating a recording element bearing an ink jet or other printed ink image to improve at least one property of the ink images on the recording element. The roller comprises a metallic core having an outside and an outer coating comprising a reaction product of: a high molecular weight, reactive cross-linkable poly(dialkylsiloxane); a cross-linked poly(dialkylsiloxane) including an oxide filler wherein the cross-linked poly(alkylsiloxane) has a weight average molecular weight before cross-linking from about 5,000 to about 80,000; and one or more silane cross-linking agents.

The roller is coated with the described composition, which may overlie a metal core that may be hollow or cylindrical and may be of any suitable metal or plastic having a sufficient strength and thermal conductivity. The coating is desirably from about 0.04 mm to about 6 mm thick. The coating may also include fillers, as discussed below.

According to the present invention, as shown in FIG. 1, substrates or recording elements 24 bearing ink jet or other printed ink images may be passed along a belt or other conveyor system 22 past a dryer shown schematically at 26, a set of drying rollers 20, a second set of dryers 28 and finally through between a fuser roller 30 and a pressure roller 32. The substrates as shown are supported above the conveyor and may be dried at 28 by air drying, heat drying, infrared drying or the like as known to those skilled in the art. The drying may be continued to a desired point and is controlled to avoid bubbling or otherwise deforming the ink image. The substrate bearing the image is then passed between rollers 20 where additional drying is accomplished. The substrate may then be passed through a pair of dryers 28 and than between fusing roller 30 and pressure roller 32 to fuse the image. Such processes are particularly useful when fuseable compounds such as polymeric materials as used in electrophotographic copying are included in the ink.

In the use of processes such as shown in FIG. 1, any one of the components may be used alone or in combination with the others. For instance, only a dryer 26 may be used in some instances. In such instances, the durability of the ink print is improved to a certain extent but not to the extent typically achieved by the use of polymeric inks that are subsequently fused. Similarly the use of the drying rollers 20, which are heated, may be used alone or in conjunction with first dryer 26. Similarly dryers 26 and 28 are shown to illustrate heating from both sides of belt 22 and may be used alone. Similar results are achieved by this approach to the use of first dryer 26 alone. Any one of the first dryer 26, drying rollers 20 or dryers 28 can be used alone or in conjunction with fuser roller 30 and pressure roller 32. In other words, the print image is dried to the extent necessary to permit passage through the fusing step without damage to the ink print image. Typically most of the solvent and water is removed from the printed image prior to fusing between rollers 30 and 32.

By contrast to operations in electrophotographic copying wherein well known materials are used on the surfaces of rollers 30 and 32 and could be used on rollers 20, it has been found that the surface coatings usually used on such rollers are not effective to achieve desirable release properties in the drying and fusing of printed ink images.

Accordingly, a new composition has been developed for use in coating such rollers to achieve desired release properties. It is particularly important that rollers 20, which contact the print before the removal of substantial quantities of water or solvent liquids have desirable release properties. It is also important that fuser roller 30 and pressure roller 32 have desirable release properties, but it is anticipated that the difficulty in obtaining suitable release performance will be greater with the rollers 20 which contact the “wetter” ink print image.

It is believed that the use of the rollers as described in the present invention will be equally useful not only with ink jet images but with other ink print images, particularly those that include quantities of fusable polymers such as found in toners used in electrophotographic copying. With all such inks, the composition and roller of the present invention are considered to provide improved release properties as required for suitable process operation.

There is a need for ink jet system technologies that enable high throughput production of photographic quality, durable prints for medical diagnostic and photo printing applications. This requires a converting station consisting of a novel converting rollers system that is able to provide the throughput with a good release and durable characteristics to the recording element when processing an ink image.

In accordance with the present invention, there is provided a roller member having a metallic core and a layer of material formed over the metallic core, the layer including composite materials, comprising

(a) a high molecular weight, reactive cross-linkable poly(dialkylsiloxane);

(b) a cross-linked poly(dialkylsiloxane) incorporating an oxide, wherein the poly(dialkylsiloxane) has a weight average molecular weight before cross-linking from about 5,000 to 80,000; and

(c) one or more silane cross-linking agents.

An advantage of the present invention is that incorporating a high molecular weight reactive polyfunctional poly(alkylsiloxane) polymer containing alkyl groups containing from 1 to about 6 carbon atoms causes an improvement in fusible ink image-bearing substrate release from the fusing and drying rollers.

Another advantage of the current invention is that it successfully increases the release characteristics resulting in the advantages listed above without sacrificing the image toughness and without significantly affecting the image wear properties.

Another advantage of the current invention is that it permits incorporation of higher amounts of poly(dimethyl)siloxane than were non-reactive poly(dimethyl)siloxane oil to be incorporated.

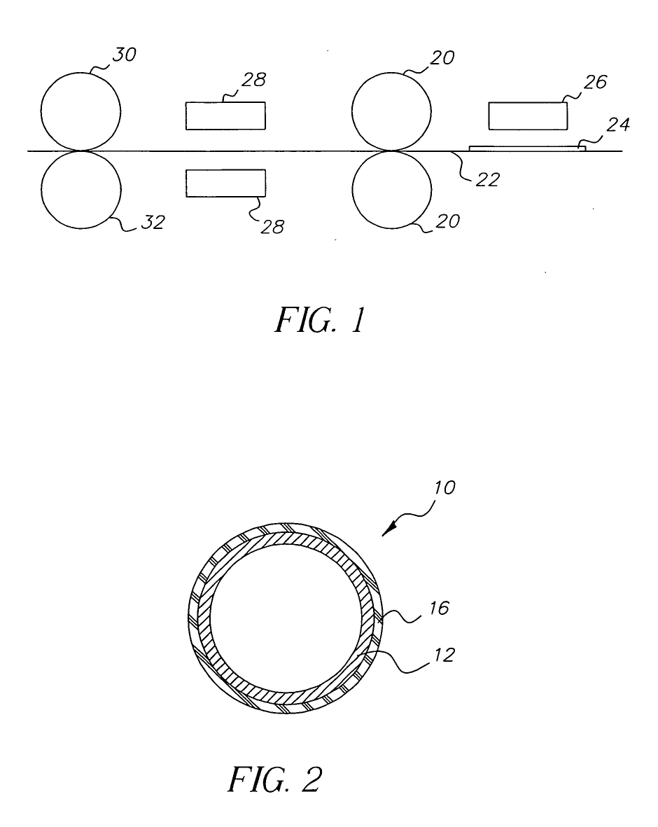

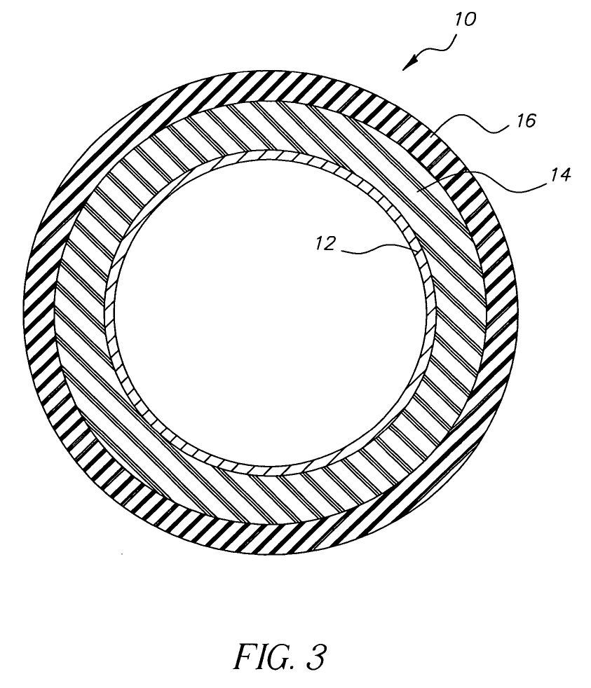

Referring to FIG. 1, a fuser roller 30 and a pressure roller 32 comprise a base member 12, which is generally in the form of a solid or hollow cylindrical shaft or core typically from 8 mm to 40 mm in diameter formed of an aluminum or stainless metal tube. Disposed on the base member 12 is base cushion layer 14, which can have a thickness that varies, but is preferably from 0.5 mm to about 6 mm thick. It can be desirable for the cushion layer to be a thermally conductive material such a metal oxide filled silicone elastomer. A converting roller outer layer 16 is disposed over the intermediate cushion. The outer layer 16 includes a material that will be discussed later in detail. The thickness of the outer layer is preferably from 0.04 mm to 6 mm thick. Usually the outer layer 16 is thinner than cushion layer 14. In practice, the base cushion layer 14 may be omitted as shown in FIG. 2.

The outer layer 16 of the fuser roller 30 of the invention comprises a reaction product of a cross-linked poly(dialkylsiloxane) and a cross-linkable poly(diaryl)siloxane.

Outer layer 16 of roller 30 of the invention includes a cross-linked poly(dialkylsiloxane) including at least one oxide filler. The fillers are oxides or mixtures of oxides. Typical oxides include metal oxides such as aluminum oxide, iron oxide, tin oxide, zinc oxide, copper oxide and nickel oxide. Silica (silicon oxide) can also be used.

Suitable materials for a cross-linked poly(dialkylsiloxane) incorporating an oxide, wherein the poly(dialkylsiloxane) has a weight average molecular weight before cross-linking from about 5,000 to about 80,000 are filled condensation-cross-linked poly(dimethylsiloxane) elastomers disclosed in U.S. Pat. No. 5,269,740 (copper oxide filler), U.S. Pat. No. 5,292,606 (zinc oxide filler), U.S. Pat. No. 5,292,562 (chromium oxide filler), U.S. Pat. No. 5,548,720 (tin oxide filler), and U.S. Pat. No. 5,336,539, (nickel oxide). These patents are hereby incorporated in their entirety by reference.

Silanol-terminated poly(dialkylsiloxane) polymers and methods of their preparation are well known. They are readily commercially available, e.g., from Huls America, Inc., (United Chemical) 80 Centennial Ave., Piscataway, N.J., U.S.A., and have the repeating unit structure:

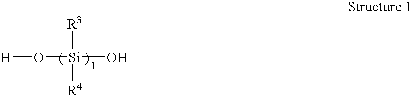

“1” is an integer such that the Structure (I) polymer has a weight average molecular weight of from about 5,000 to about 80,000. R³ and R⁴ are independently alkyl groups such as methyl, ethyl, propyl, butyl, pentyl, or hexyl. If the molecular weight were below about 5,000, the final cross-linked poly(dialkylsiloxane) would have a high cross-linked density that would make the material too hard and brittle, and not resilient enough to serve practically in a roller outer layer. If the molecular weight were above about 80,000, the final cross-linked poly(dialkylsiloxane) would be too unstable under conditions of high temperature and cyclic stress (i.e., there would be too much creep and change in hardness over time).

The poly(dialkylsiloxane) polymers can be cross-linked with multifunctional silanes. The multifunctional silanes that can serve as cross-linking agents for the Structure (I) polymers are well known for this purpose. Each of such silanes comprises a silicon atom bonded to at least three groups that are functional to condense with the hydroxy end groups of the Structure (I) polymers to thereby create siloxane cross-links through the silicon atom of the silane. The functional groups of the silanes can be, for example, acyloxy (R—COO—), alkenoxy (CH₂═COO—), alkoxy (R—O—), dialkylamino (R₂N—), or alkyliminoxy (R₂C═N—) groups, wherein R represents an alkyl or alkenyl moiety containing from 1 to about 6 carbon atoms. Some specific examples of suitable multifunctional silane cross-linking agents are methyltrimethoxysilane, tetraethoxysilane, methyltripropenoxysilane, methyltriacetoxysilane, propyltrimethoxysilane, phenyltrimethoxysilane, methyltris(butanone oxime)silane, and methyltris(diethylamino)silane.

When alkoxy functional groups are employed, the condensation cross-linking reaction is carried out with the aid of a catalyst, such as, for example, a titanate, chloride, oxide, or carboxylic acid salt of zinc, tin, iron, or lead. Some specific examples of suitable catalysts are zinc octoate, dibutyltin diacetate, ferric chloride, and lead dioxide.

The primary cross-linked poly(dialkylsiloxane) material used for the Examples is marketed under the trademark STYCAST 4952, a trademark of Grace Specialty Polymers, Massachusetts. STYCAST 4952 material is composed of a network-forming polymer that is a silanol-terminated, hydroxy-) poly(dimethyl)siloxane. The number of repeat units is such that the silanol-terminated poly(dimethyl)siloxane (\grave{α}-ω-dihydroxy)poly(dimethylsiloxane) has a weight average molecular weight from about 5,000 to about 80,000. This composition includes the filler. The filler is from about 55 to about 70 weight percent (wt. %) aluminum oxide and about 5 to about 15 wt. % iron oxide particulate fillers. Polyethylsilicate (condensed tetraethylorthosilicate) is present as the cross-linking agent.

Specific examples of useful catalysts for this polymer are dibutyltin diacetate, tin octoate, zinc octoate, dibutyltin dichloride, dibutyltin dibutoxide, ferric chloride, lead dioxide, or mixtures of catalysts such as CAT50 catalyst (sold by Grace Specialty Polymers, Massachusetts). CAT50 catalyst is believed to be a mixture of dibutyltin dibutoxide and dibutyltin dichloride diluted with butanol.

The second component of the outermost layer is a high molecular weight reactive poly(alkylsiloxane) polymer. The high molecular weight reactive poly(alkylsiloxane) polymer has repeating units of the formula,
(R¹ₐSiO(_{4-a)/2})
where R¹ represents alkyl groups containing from 1 to about 6 carbon atoms and where a is 0-3.

Further, the high molecular weight reactive poly(alkylsiloxane) polymer is a liquid blend comprising about 60 to 80 wt. % of a difunctional poly(dialkylsiloxane) having a number average molecular weight from about 140,000 to about 150,000 and preferably about 150,000, and from about 20 to about 40 wt. % of a poly(trialkyl) silyl silicate resin having monofunctional and tetrafunctional repeating units in an average ratio of between 0.8 and 1 to 1, and having a number average molecular weight from about 1,500 to about 2,500 and preferably about 2,200.

For the preferred embodiment, the various components of the composite material can have the following percentages:

(a) 10-60 wt. % \grave{α}-ω-hydroxy-poly(dialkylsiloxane) having a weight average molecular weight from 5,000 to 80,000

(b) 55-85 wt. % oxide fillers, preferably the combination of 55-70 wt. % aluminum oxide and 5-15 wt. % iron oxide;

(c) 0.5-5 wt. % cross-linking agent;

(d) about 30 wt. % high molecular weight reactive poly(dialkylsiloxane) polymer; and

(e) from 0.05 to about 2 wt. % catalyst.

To form the outer layer 16 of a fuser member in accordance with the invention, a slight excess of the stoichiometric amount of silane cross-linking agent to form cross-links with all the hydroxy end groups, and the appropriate amount of filler are thoroughly mixed on a roll mill jar. The high molecular weight reactive cross-linkable poly(dialkylsiloxane)polymer is also added at this time. If a catalyst is necessary, it is then added to the mixture with thorough stirring. The mixture is then degassed. The mixture can then be ring coated onto a metal core or a base cushion layer. The base cushion layer 14 usually is a thermally conductive metal oxide filled silicone elastomer such as the STYCAST 4952 material described above. The primary cross-linked poly(dialkylsiloxane) can be injection mold or bladed coated onto the core. The base cushion layer 14 remains in a mold for a time sufficient for some cross-linking to occur (e.g., 4 hours). The roller is then removed from the mold and heated to accelerate the remaining cross-linking. Alternately the mix can be applied to the core by methods other than molding as known to those skilled in the art.

It is currently preferred to apply the base cushion layer 14 over the metallic core 12 which has been conversion coated and primed with metal alkoxide primer in accordance with commonly assigned U.S. Pat. No. 5,474,821, which is hereby incorporated in its entirety by reference. The outer layer 16 is coated over base cushion layer 14. One or more methods of layer-to-layer adhesion improvement, such as corona discharge treatment of the underlying coating layer surface, may be applied prior to application of the material of this invention. Various methods of layer-to-layer adhesion improvement are well known to those skilled in the art.

The following examples are presented for a further understanding of the invention. The examples are illustrative of specific embodiments of the present invention and should not be construed as limiting the scope thereof.

Unless otherwise indicated, all parts and percentages are by weight and temperatures are in degrees of Centigrade (C).

### EXAMPLE 1

Two hundred and fifty grams of STYCAST 4952 cross-linked poly(dimethyl)siloxane incorporating an oxide was blended with 10 g high molecular weight reactive polyfunctional poly(dialkylsiloxane) polymer marketed under the trademark SFR-100 by GE silicones and 70 gm of methyl ethyl ketone in a roll mill jar. CAT50 (trademark of Grace Specialty Polymers) catalyst (a dibutyltindiacetate) was added at the rate of one part of catalyst to 300 parts by weight STYCAST 4952 material. The mixture was degassed and ready to be ring coated on the blade coated roller with EC-4952 (trademark of Grace Specialty Polymers) base cushion layer.

### EXAMPLE 2

A cylindrical stainless steel core was cleaned with dichloromethane and dried. The core was then primed with a metal alkoxide type primer GE4004, marked by General Electric. The core was then bladed coated with EC-4952 silicone at a catalyst ratio of 300 to 1. Oven cured for 15 hours using the convection oven with 3 hours ramp up to 205 C and then maintaining 205 C for 12 hours. Rollers were the grounded to 0.5 mm and 1.5 mm blanket layer thickness and ring coated using the Example 1 mixture. The rollers were oven cured using the same 15 hours cure procedure described above.

As well known to those skilled in the art, fusing techniques and equipment used to fuse toner images in the electrophotographic copying and production of documents containing fused toner images involves the use of significantly different materials than are used in the ink jet and other ink printing applications. Specifically the toner comprises a dry polymeric material that is electrostatically positioned on a substrate until fused. By contrast, ink jet printing images or other images containing ink constituents that basically comprise carriers and the like that carry the image-forming materials in a volatile mixture. Even when such materials are modified to include toner-like polymeric materials that are fusable, the materials still contain significant quantities of volatile materials. To some extent these materials can be removed by heating methods, such as infrared, convection heating, air blowing or the like. Each of these drying methods has certain disadvantages. In any event, printed images are frequently dried. In some instances drying is partly accomplished by pairs of rollers. In many instances when fusable materials are included in the inks, the ink images are improved significantly in their stability by fusing.

The rollers used for such operations must release cleanly from the surface of the substrates bearing the ink images as the operations are completed. It has been found that many of the rollers used in fusing operations with toner images do not release well from ink images. Accordingly, the present invention is directed to the preparation of rollers and a composition for their outer surface that release well from ink images on a substrate.

While the present invention has been described by reference to certain of its preferred embodiments, it is pointed out that the embodiments described are illustrative rather than limiting in nature and that many variations and modifications are possible within the scope of the present invention.

What is claimed is:

1. A coated roller having an outer coating comprising:
a) a metallic core having an outside surface;
b) a coating on said outside surface comprising a reaction product of:
i) a high molecular weight, reactive cross-linkable poly(dialkylsiloxane);
ii) a cross-linked poly(dialkylsiloxane) including an oxide filler wherein the cross-linked poly(alkylsiloxane) has a weight average molecular weight before cross-linking from about 5,000 to about 80,000; and
iii) one or more silane cross-linking agents.

2. The roller of claim 1 wherein cross-linked poly(alkylsiloxane) contains alkyl groups containing from 1 to about 6 carbon atoms.

3. The roller of claim 2 wherein the alkyl groups are methyl groups.

4. The roller of claim 1 wherein the silane cross-linking agents are multifunctional silanes.

5. The roller of claim 4 wherein the silane cross-linking agents are selected from silanes having functional groups selected from the group consisting of acyloxy, alkenoxy, alkoxy, dialkylamino, alkylamino and combinations thereof.

6. The roller of claim 1 wherein a catalyst for a condensation cross-linking reaction is used.

7. The roller of claim 1 wherein the cross-linkable poly(alkylsiloxane) comprises:
a) about 60 to about 80 wt. % of a difunctional poly(alkylsiloxane) having a number average molecular weight from about 140,000 to about 150,000 and from about 20 to about 40 wt. % of a poly(trialkyl)silyl silicate resin having a monofunctional and trifunctional repeating units in a ratio of 0.8 to 1:1; and,
b) having a number average molecular weight from about 1,500 to about 2,500.

8. The roller of claim 1 wherein the reaction product contains from about 55 to about 85 wt. % filler based upon the weight of the reaction product.

9. The roller of claim 1 wherein the filler is selected from the group consisting of aluminum oxide, iron oxide, tin oxide, zinc oxide, copper oxide, nickel oxide, silicon dioxide and combinations thereof.

10. The roller of claim 8 wherein the filler is from about 55 to about 70 wt. % aluminum oxide and from about 5 to about 15 wt. % iron oxide based upon the weight of the reaction product.

11. The roller of claim 1 wherein the cross-linked poly(alkylsiloxane) is alpha-omega-hydroxy(dimethyl)siloxane having a weight average molecular weight from about 5,000 to about 80,000.

12. The roller of claim 1 wherein a catalyst selected from the group consisting of titanates, chlorides, oxides and carboxylic acid, acid salts of zinc, tin, iron or lead and combinations thereof is present in the reaction product.

13. The roller of claim 12 wherein the catalyst is at least one of zinc octoate, dibutyltin acetate, ferric chloride and lead dioxide.

14. The roller of claim 1 wherein the roller includes a cushion layer between the outside of the metallic core and the outer coating.

15. A composition comprising a reaction product of a high molecular weight, reactive cross-linkable poly(dialkylsiloxane), a cross-linked poly(dialkylsiloxane) including an oxide filler wherein the cross-linked poly(alkylsiloxane) has a weight average molecular weight before cross-linking from about 5,000 to about 80,000, and one or more silane cross-linking agents.

16. The composition of claim 15 wherein the cross-linked poly(alkylsiloxane) contains alkyl groups containing from 1 to about 6 carbon atoms.

17. The composition of claim 16 wherein the alkyl groups are methyl groups.

18. The composition of claim 15 wherein the silane cross-linking agents are multifunctional silanes.

19. The composition of claim 18 wherein the silane cross-linking agents are selected from silanes having functional groups selected from the group consisting of acyloxy, alkenoxy, alkoxy, dialkylamino, alkylamino and combinations thereof.

20. The composition of claim 15 wherein a catalyst for a condensation cross-linking reaction is used.

21. The composition of claim 15 wherein the cross-linked poly(alkylsiloxane) comprises from about 60 to about 80 wt. % of a difunctional poly(alkylsiloxane) having a number average molecular weight of about 140,000 to about 150,000 and from about 20 to about 40 wt. % of a poly(trialkyl)silyl silicate resin having a monofunctional and trifunctional repeating units in a ratio of 0.8 to 1:1 and having a number average molecular weight from about 1,500 to about 2,500.

22. The composition of claim 15 wherein the reaction product contains from about 55 to about 85 wt. % filler based upon the weight of the reaction product.

23. The composition of claim 15 wherein the filler is selected from the group consisting of aluminum oxide, iron oxide, tin oxide, zinc oxide, copper oxide, nickel oxide, silicon dioxide and combinations thereof.

24. The composition of claim 22 wherein the filler is from about 55 to about 70 wt. % aluminum oxide and from about 5 to about 15 wt. % iron oxide based upon the weight of the reaction product.

25. The composition of claim 15 wherein the cross-linked poly(alkylsiloxane) is alpha-omega-hydroxy(dimethyl)siloxane having a weight average molecular weight from about 5,000 to about 80,000.

26. The composition of claim 15 wherein a catalyst selected from the group consisting of titanates, chlorides, oxides and carboxylic acid, acid salts of zinc, tin, iron or lead and combinations thereof is present in the reaction product.

27. The composition of claim 26 wherein the catalyst is at least one of zinc octoate, dibutyltin acetate, ferric chloride and lead dioxide.
